(19) United States
(12) Patent Application Publication
(10) Pub. No.: US 2006/0111922 A1
(43) Pub. Date: May 25, 2006

(54) Home planner system

(76) Inventors: Richard Alfonce Phillips, Oakland, CA (US); David M. Bittinger, San Francisco, CA (US)

Correspondence Address: KEVIN J. MCNEELY, ESQ., 5335 WISCONSON AVENUE, NW, SUITE 440, WASHINGTON, DC, 20015, US

(21) Appl. No.: 10/994,348

(22) Filed: Nov. 23, 2004

(51) Int. Cl. G06Q 99/00

(52) U.S. Cl. 705/1

(57) ABSTRACT

A method of preparing a customized house plan includes providing a single interface menu that includes an image of a floor plan, itemized floor plan options, and more than one option of an elevation view for a selected house plan, modifying the image of the floor plan based on the selected floor plan options and generating a one page brochure of the customized house plan that includes the image of the selected elevation view and the floor plan with the selected floor plan options.

### FIELD OF THE INVENTION

This invention relates to home design and customization, and more particularly, to methods of computer assisted design of house plans.

### BACKGROUND OF THE INVENTION

A variety of computer assisted house plan design tools are available. However, most of these are fairly complex in operation so that they can be difficult to use for the average home shopper. In particular, these design tools typically require that the user scroll through several different interface menus to customize a house plan. In addition, the customized house plan usually must be printed on several sheets of paper to get details of each floor level, the elevation view, and plan details. The home shopper that is considering various home models and developments may find that having a number of pages per home design can be confusing. Thus, a need exists for an easy to use home customization system that produces a brochure with all relevant details on a single page.

### SUMMARY

The house planner system allows a user to customize and manipulate a home plan from one interface menu and produces a brochure that includes all relevant information on one display screen or printed sheet.

In one general aspect, a method of preparing a customized house plan includes providing a single interface menu that includes an image of a floor plan, itemized floor plan options, and more than one option of an elevation view for a selected house plan, modifying the image of the floor plan based on the selected floor plan options and generating a one page brochure of the customized house plan that includes the image of the selected elevation view and the floor plan with the selected floor plan options.

Implementations may include one or more of the following features. For example, the method may include displaying a list of house plans and prompting a user to select a house plan from the list of the house plans. Another feature may be a user prompt to select a floor level of a multi-level home model. The displayed image may include a list of floor plan options for the viewed floor level.

The method may include a calculation of total square footage for the selected home model, which may be updated based on selected floor plan options. The one page brochure may include the calculated total square footage and may also include a description of the home model with bedroom and bathroom counts.

Another feature may include a user prompt to preview and/or print the one page brochure. Additionally, an archive of home models may be searched to find a physically built home model of the selected house plan. The construction costs may be estimated and/or updated and the estimate may be displayed on the one page brochure. As another feature, dimensions of each room may be illustrated with the dimensions modified based on the selected floor plan options.

The method includes a zoom tool and may also provides other user tools, such as, for example, a save plan feature or a plan notation feature.

Additional aspects and/or advantages of the invention are apparent from review of the following description and drawings or may be learned by practice of the invention.

### DESCRIPTION OF THE DRAWINGS

FIGS. 1-4 are flowcharts for the house planner system.

FIGS. 5-11 are screen shots showing use of the house planner system.

FIG. 12 shows a typical computer network for the house planner system.

### DESCRIPTION

### Detailed examples of the present invention are described below and are illustrated in the accompanying drawings, in which like reference numerals refer to like elements throughout.

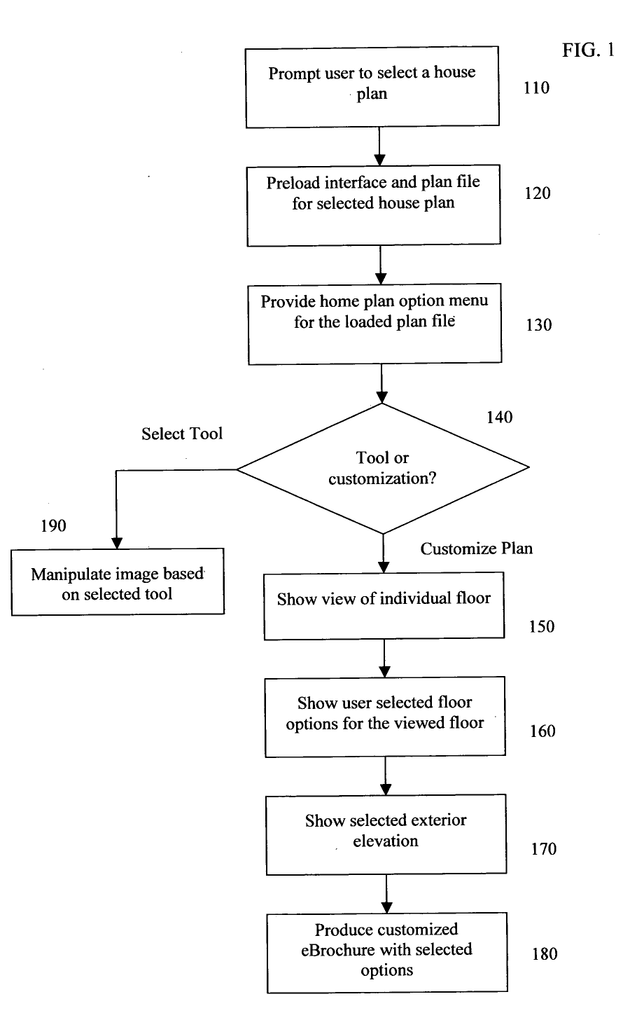

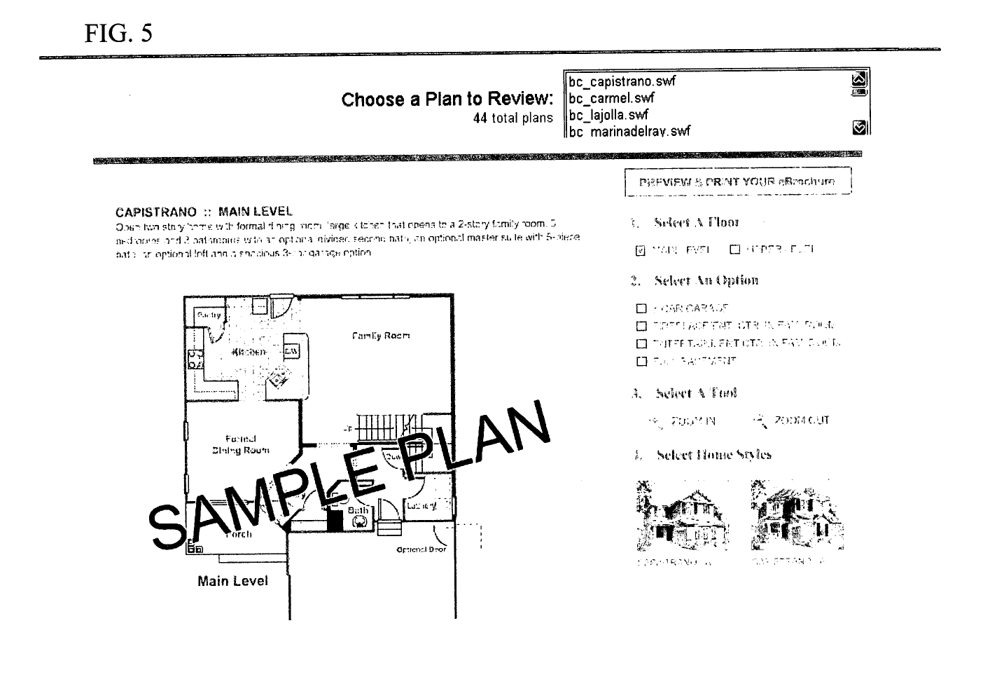

FIG. 1 is a flowchart of a home planner system, which allows a user to customize and manipulate a home plan from one interface menu and produces a brochure that includes all relevant information on one display screen or printed sheet. Initially, the user is presented with a menu of home models. The user is prompted to select a house plan (110) as shown in the screen shot of FIG. 5. The house model may be chosen from a variety of home models, including single and multi-level homes that are available in a development community.

Upon selection of the house plan, the system preloads an interface and plan file for the selected house (120). The interface and plan file preloads include a number of operations, including initialization of variables, selecting an initial floor, and loading eBrochure information for each floor. The set of option labels and elevations corresponding to the selected house plan are also loaded. Variable information is accessed to set community and sales office information. After the number of options and elevations has been set, the interface menu is sized and collapses to the maximum usable space for viewing.

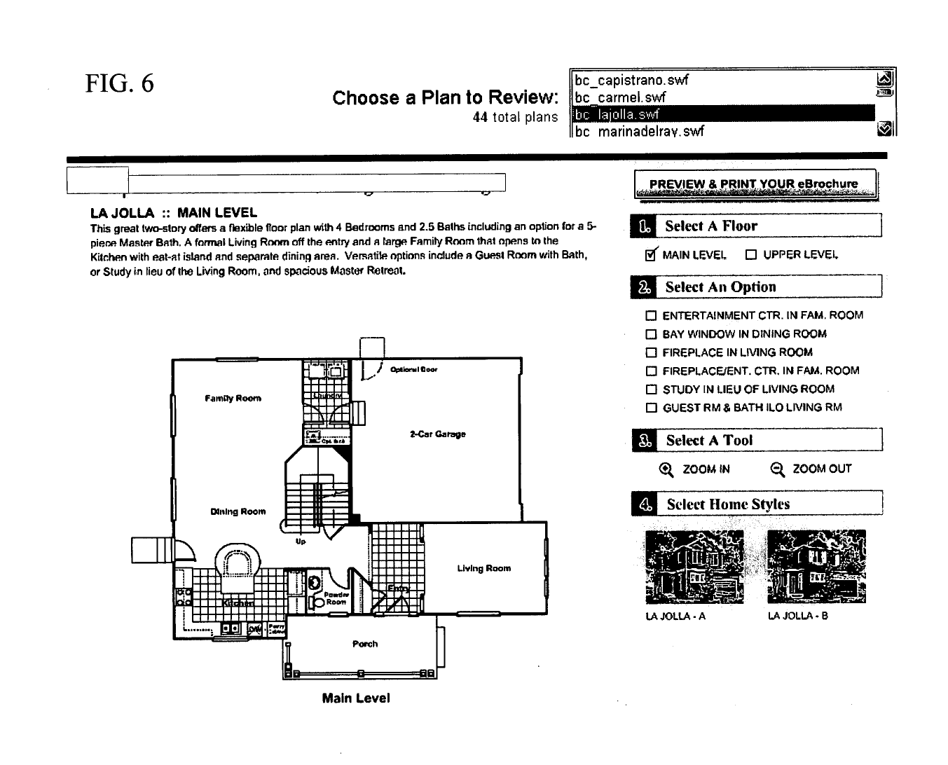

The user is presented with the interface menu (130) as shown in the screen shot of FIG. 6. The interface menu has a comprehensive list of options available from one screen, including, for example, the ability to view each floor with associated floor features, viewing tools, elevation views and print and preview options. The menu initially displays the selected house plan with certain default parameters, such as, for example, a view of the main level floor plan.

The interface menu allows the user to manipulate the screen view with a tool or he can choose to select one of the customization options (140). When the user selects a floor, the main level floor plan view is replaced by the selected level's floor plan (150).

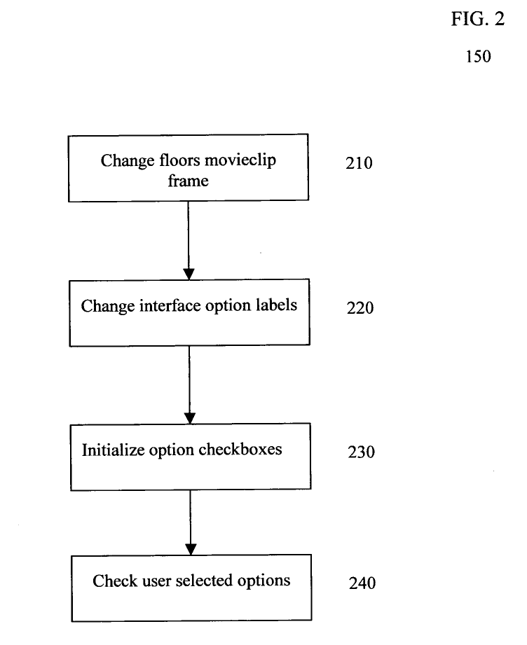

Referring to FIG. 2, when the user changes floors, the plan movie clip changes frames to select the proper floor and change the plan label (210). After the floor has been changed, available options for that floor are made available by changing the interface option labels (220). All option checkboxes are initially set to unchecked (230). As the user selects an option, a check is displayed for that floor option (240).

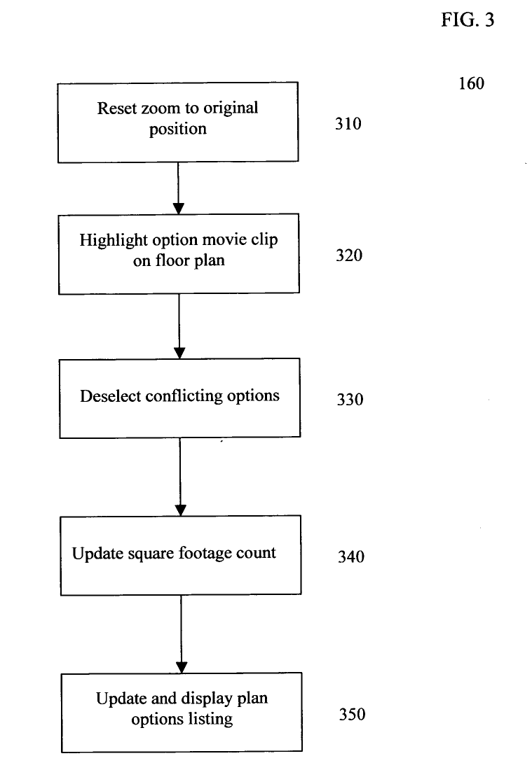

Referring to FIG. 3, when the user selects a floor option the zoom tool resets to the display to the original size and the floor position is returned to its original coordinates (310). The selected option is then displayed and highlighted on the floor plan in a specific color (320). If two options are inconsistent or overlap, the option being selected deselects the option occupying its space on the floor plan (330). The square footage of each option is also tracked so that a total square footage can be calculated (340). The selected options are included in a plan options listing to inform the user of the options that have been selected (350).

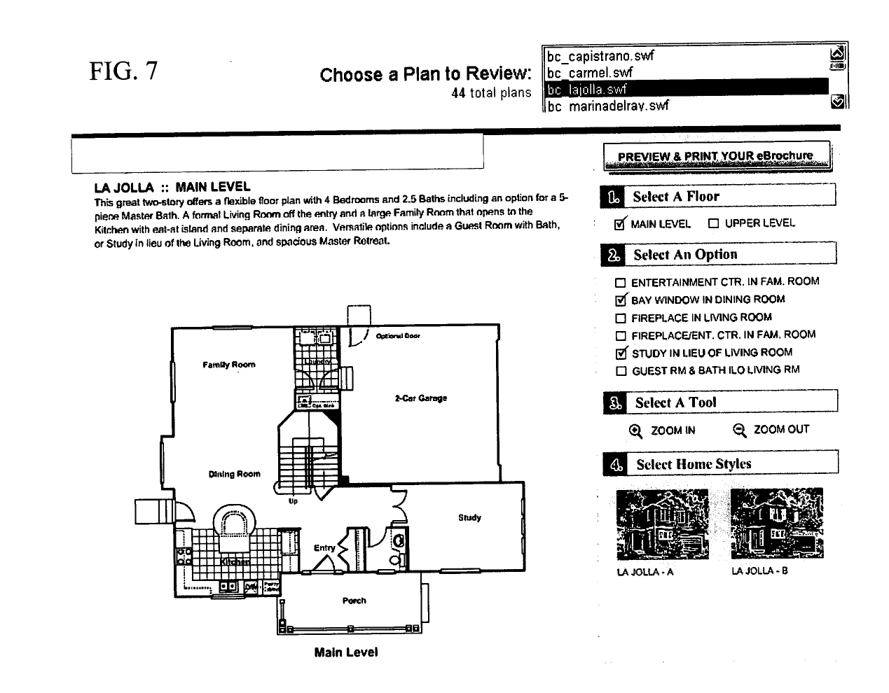

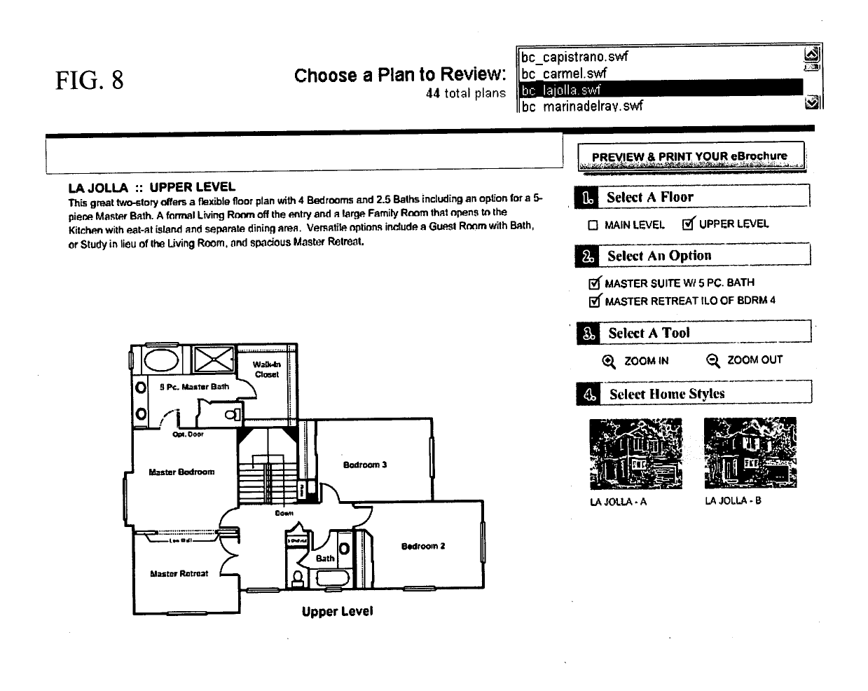

FIGS. 7 and 8 illustrate screen shots of main level and upper level floor plans with various options selected. Referring to the main level shown in FIG. 7, the user may make selections from six options. If the user chooses, for example, “Bay Window in Dining Room” and “Study in Lieu of Living Room”, the associated options checkboxes are checked and the text for each phrase is highlighted or colored. The graphic image of the main level floor plan is also modified to illustrate the options.

Referring to the upper level floor plan shown in FIG. 8, the user may make selections from two options. If the user chooses both options labeled “Master Suite w/5 pc Bath” and “Master Retreat ILO of BDRM 4”, the associated option checkboxes are checked and the text for each phrase is highlighted. The upper level floor plan is also modified to illustrate the master bath and master retreat options.

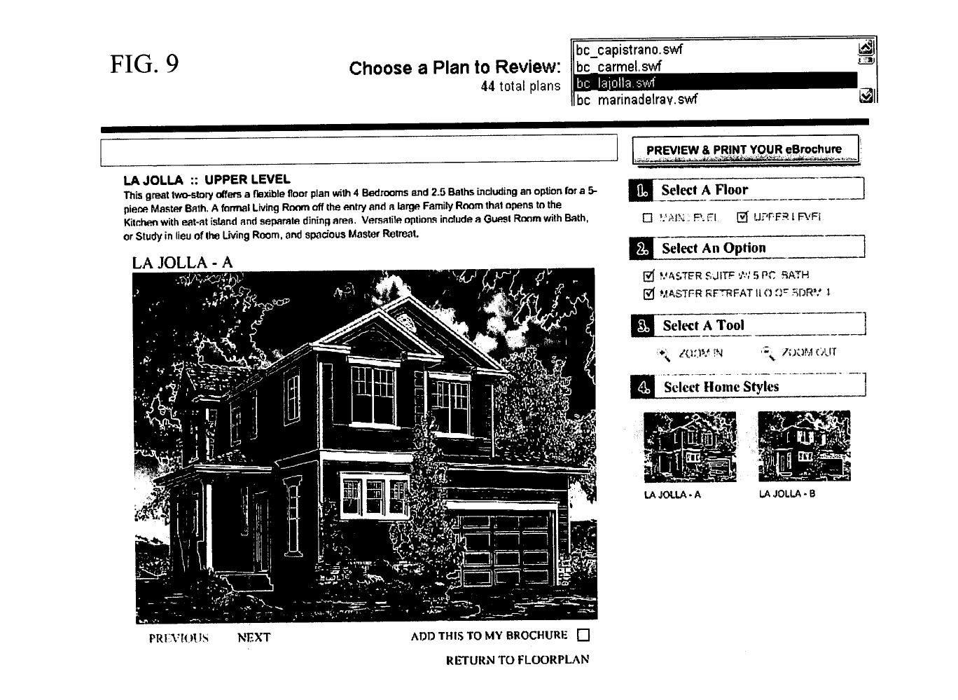

Referring again to FIG. 1, the user selected home style or exterior elevation is displayed (170) as shown in the screen shot of FIG. 9. In the illustrated example, the user can select from two home styles. The user may select home exterior colors, such as, for example, taupe as opposed to burgundy, or building materials that are used, such as, for example, brick as opposed to stucco or slate roofs as opposed to Spanish tile.

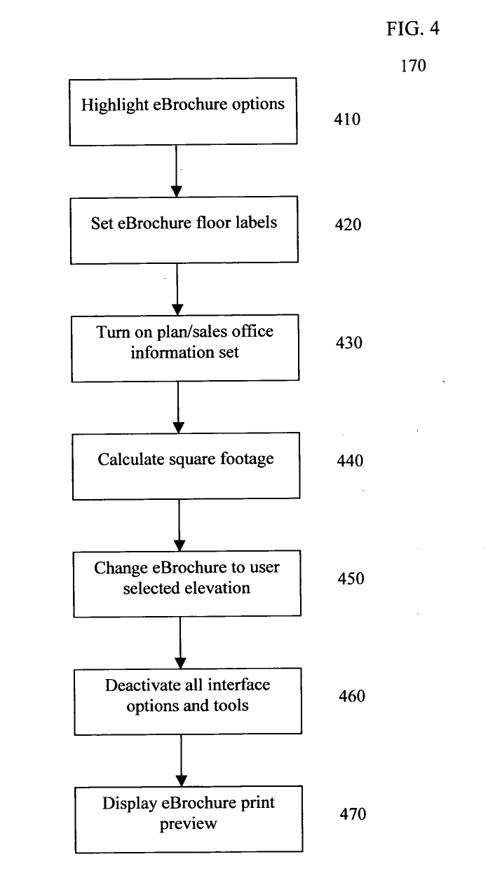

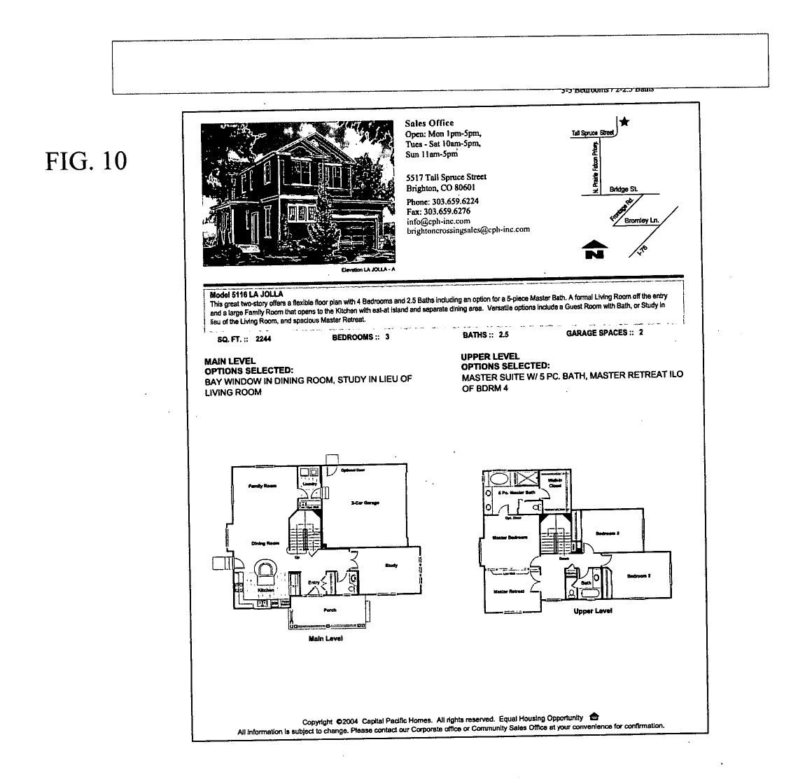

When customization options are complete, the eBrochure is generated in response., to the user's print or preview request (180) as shown in the screen shot of FIG. 10. Referring to FIG. 4, generation of the eBrochure entails several operations. Based on the saved options that the user has selected in the interface, the corresponding options are highlighted on the eBrochure (410). The eBrochure floor/option listing labels are set dynamically from variables contained in the plan file (420) and overall plan and sales office information are also set on the eBrochure from plan variables.

The total square footage and bedroom and bathroom count totals are adjusted and reflected on the eBrochure (440). The large elevation image on the eBrochure is changed to reflect the user-selected elevation from the interface (450). Finally, all tools interface options are disabled for the preview (460) and the eBrochure print preview is displayed to the user for review (470).

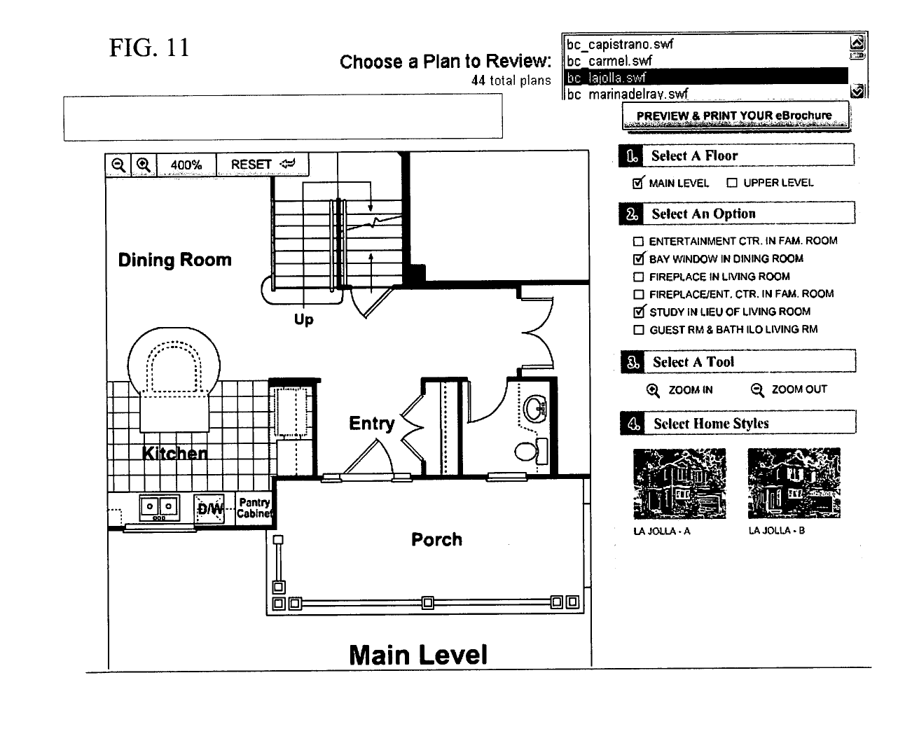

Referring again to FIG. 1, various tools can be made available so that the user can manipulate and further examine the home models (190). These tools include a zoom feature where the user can examine a floor plan in more detail as shown in the screen shot of FIG. 11. The zoom tool allows inspection of plan details up to 400% of the original size. While the zoom tool is engaged, the user may drag and drop the plan to view other details.

Another tool is a photo gallery that supplies actual photos of actual rooms within model residences with previous/next navigation, similar to that used to view exterior elevations. Still another tool is a flip plan option, by which the user may view a representation of the plan mirrored about the horizontal axis. The user may also employ another “sent to friend” tool by which the user sends a dynamic email message containing a link to the plan being viewed.

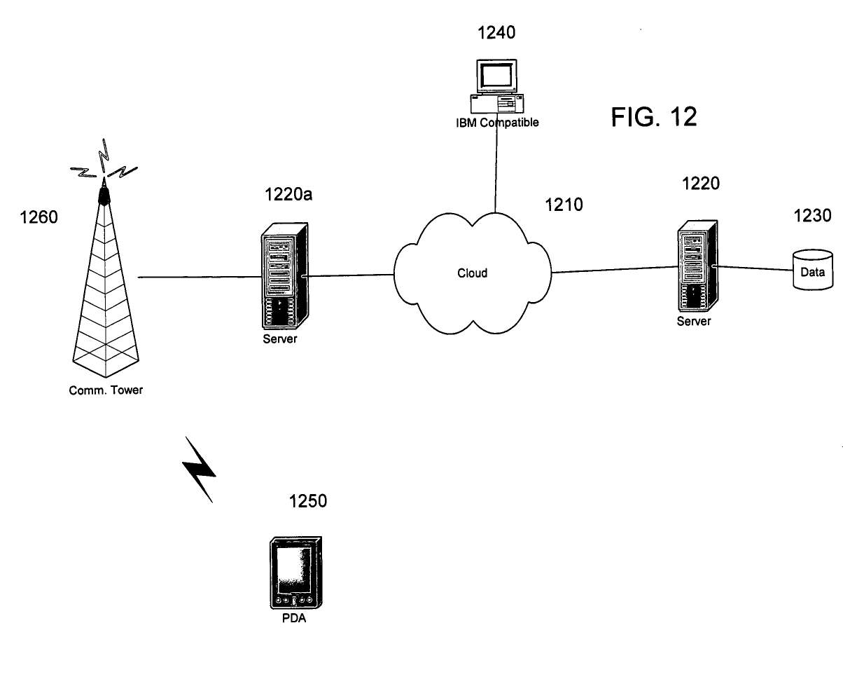

A note pad feature allows the user to write notes on the plans prior to printing the ebrochure. For example, the user may write “do not like fireplace next to kitchen nook.” A save plan feature allows the user to saved the personalized plan and elevation selections for later retrieval. The home planner system may be used by remote web access as shown in the Internet architecture of FIG. 12. The Internet 1210 connects a conventional Internet server 1220 and its corresponding file database 1230. The server 1220 communicates with the Internet via the HTTP/TCP/IP protocol. Hyperlink addresses used in WWW browsers and WWW documents correspond to logical addresses, which are used for IP routing.

A user at a PC 1240 can access the home planner application by connecting to the Internet 1210 via the HTTP/TCP/IP protocol by running a Web browser application which supports hyperlinks based retrieval of documents stored in Web files. Similarly, a user with a PDA 1250 can access the home planner application by connecting to the Internet 1210 via a wireless link to a communication tower 1260 which is connected to the Internet 1210 by a server 1220a.

Although a few aspects of the present invention have been shown and described, those skilled in the art will appreciate that changes may be made without departing from the principles and spirit of the invention, the scope of which is defined in the following claims and their equivalents.

I claim:

1. A method of preparing a customized house plan, comprising:
providing a single interface menu that includes an image of a floor plan, itemized floor plan options, and more than one elevation view for a selected house plan;
modifying the image of the floor plan based on the selected floor plan options; and
generating a one page brochure of the customized house plan that includes the image of a selected elevation view and the floor plan with the selected floor plan options.

2. The method of claim 1, further comprising:
displaying a list of house plans; and
prompting a user to select a house plan from the list of the house plans.

3. The method of claim 1, further comprising:
prompting the user to select a floor level where the selected house plan includes a multi-level home model; and
wherein the providing the user with the image of the floor plan includes providing the image of the floor plan and the single menu of the itemized floor plan options for the selected floor level of the multi-level home model.

4. The method of claim 1, further comprising:
calculating a total square footage of the selected home model;
wherein the generating the one page brochure includes displaying the calculated total square footage.

5. The method of claim 4, wherein the displaying the total square footage includes updating the calculated total square footage based on the selected floor plan options.

6. The method of claim 1, wherein the generating the one page brochure includes a description of the home model with a bedroom count and a bathroom count.

7. The method of claim 1, further comprising:
prompting the user to preview the one page brochure.

8. The method of claim 1, further comprising:
prompting the user to print the one page brochure.

9. The method of claim 1, further comprising:
searching an archive of home models matching the selected house plan;
wherein the generating the one page brochure includes displaying a physical address of a constructed home model that matches the selected house plan.

10. The method of claim 1, further comprising:
estimating a construction cost of the selected home model;
wherein the generating the one page brochure includes displaying the estimated construction cost on the one page brochure.

11. The method of claim 10, wherein the estimating the construction cost comprises updating the construction cost with the cost of the selected floor plan options.

12. The method of claim 1, wherein the generating the one page brochure further includes providing dimensions of each room of the selected house plan.

13. The method of claim 12, wherein the providing dimensions further includes modifying the dimensions based on the selected floor plan options.

14. The method of claim 1, further comprising providing a zoom tool that enlarges or reduces the image of the selected floor plan.

15. A computer program stored on a computer readable medium, comprising:
a display code segment that causes a computer to display a single interface menu that includes an image of a floor plan, itemized floor plan options, and more than one option of an elevation view for a selected house plan; and
a production code segment that cause a computer to produce a one page brochure of the customized house plan, the one page brochure including the image of the selected elevation view and the floor plan of each floor with the selected floor plan options.

16. The computer program of claim 15, further comprising:
a notation code segment that causes a computer to include user notations on the one page brochure.

17. The computer program of claim 15, further comprising:
a modify code segment that causes a computer to modify the displayed image of the floor plan based on user selections; and
a save plan code segment that causes a computer to electronically store the modified floor plan.

18. A home design system, comprising:
a display module providing instruction to a computer to display a single interface menu that includes an image of a floor plan, itemized floor plan options, and more than one elevation view for a selected house plan; and
a generation module providing instruction to a computer to generate a one page brochure of the customized house plan, the one page brochure including the image of the selected elevation view and the floor plan of each floor with the selected floor plan options.
